(19) United States
(12) Patent Application Publication
(10) Pub. No.: US 2009/0294192 A1
(43) Pub. Date: Dec. 3, 2009

(54) APPARATUS FOR GENERATING CURRENT, MOTOR VEHICLE WITH AN ELECTRIC DRIVE AND AN APPARATUS OF THIS TYPE

(76) Inventor: Veit Wilhelm, Leonberg (DE)

Correspondence Address: PATENT CENTRAL LLC;Stephan A. Pendorf, 1401 Hollywood Boulevard, Hollywood, FL, 33020, US

(21) Appl. No.: 12/278,170

(22) PCT Filed: Feb. 2, 2007
(86) PCT No.: PCT/DE2007/000219

§ 371 Date: Nov. 26, 2008

(30) Foreign Application Priority Data
Feb. 3, 2006 (DE) 102006005477.6

(51) Int. Cl. B60K 6/46; H02J 7/35

(52) U.S. Cl. 180/65.245; 320/101; 903/905

(57) ABSTRACT

The invention relates to an apparatus for generating electricity, and also to a motor vehicle with an electric drive, and an apparatus of this type. The apparatus for generating electricity has a heating device, in particular an internal combustion engine for providing kinetic energy, with the additional output of thermal energy, which internal combustion engine is firstly coupled to a generator for converting the kinetic energy into electrical energy and secondly is coupled to a device for converting the thermal energy into electrical energy, wherein the internal combustion engine is designed in such a way that it is constantly operated with maximum efficiency. The motor vehicle with an electric drive has a storage device for electrical energy which is charged by the above-described apparatus for generating electricity.

The invention concerns a device for producing electricity, as well as a motor vehicle with electric drive, and an apparatus of this type. An apparatus of this type for production of electricity is known for example from DE19610382A1 or DE10054022A1.

In an internal combustion engine, under optimal operating conditions, the “Faust” formula applies, that is, one-third of the energy contained in the fuel is converted into kinetic energy, while respectively one-third is transmitted to the coolant and one-third to the exhaust gas. Outside of the optimal operating conditions, the proportion converted to kinetic energy is even lower.

For this reason, it is attempted in DE19610382A1 or DE10054022A1 to convert the thermal energy stored in the coolant and exhaust gas into kinetic energy in order therewith to support the internal combustion engine.

In conventional motor vehicles, it is besides this usual to convert a small portion of the kinetic energy from the internal combustion engine into electrical energy by means of an alternator. Electrical energy is stored in a battery, and is supplied to users such as ignition and lighting.

Besides the internal combustion engine driven motor vehicles, there are also electrical driven motor vehicles, which derive the necessary electrical energy from externally filled batteries or, more recently, from fuel cells.

Besides this there are the so-called hybrid vehicles, which can be propelled by an internal combustion engine, as well as a battery-powered electric motor, and as well as by both simultaneously. Pure electric propulsion is possible in such vehicles only for short periods of time and at comparatively low loads and is limited by the battery being utilized. Under high load conditions an electric motor can serve as an amplifier or a so-called booster for the internal combustion engine.

It is the task of the invention to provide an alternative electric driven motor vehicle as well as an apparatus for production of the electricity required therefore.

With respect to the device for production of electricity, the invention is set forth in the characterizing portion of patent claim 1. In the characterizing portion of patent claim 6, the inventive motor vehicle is set forth. The further claims define advantageous embodiments and further developments of the inventive device and the inventive motor vehicle.

With respect to the apparatus for production of electricity, the task is inventively solved thereby, that it includes an internal combustion engine for providing kinetic energy which additionally emits thermal energy, which internal combustion engine is coupled with a generator for transforming the kinetic energy into electrical energy, and is additionally coupled with a device for transforming the thermal energy of the internal combustion engine into electrical energy, wherein the internal combustion engine is set up in such a matter, that it is constantly operated in a maximal degree of efficiency.

On the one hand, the inventive apparatus distinguishes itself from the above-described state of the art thereby, that thermal energy of the internal combustion engine, instead of being converted as conventional into kinetic energy, is now converted into electrical energy. The transforming occurs preferably by a thermal-electric means, for example using a thermo-element or thermo-ionic converter. A detour via kinetic energy (Clausius-Rankine cycle) is also conceivable. Electrical energy has the advantage, that it is simpler and more efficient to transmit, in particular with lightweight components, that is, conductors.

On the other hand, the inventive apparatus differentiates from the preceding state of the art thereby, that the internal combustion engine is arranged in such a manner, that it is constantly operated at a maximal degree of efficiency. In contrast thereto, internal combustion engines according to the state of the art are frequently or primarily operated far from an optimal degree of efficiency, in particular while operating in city traffic.

In accordance with the invention the degree of efficiency is preferably optimized towards a maximal production of electrical energy, wherein it is inconsequential whether the total maximum is an individual optimum of the thermal energy of the exhaust gas and/or the coolant (for example water or oil) or the kinetic energy, or is a compromise of individual suboptimal values, which however in sum produce a total maximal electrical energy.

Alternatively the internal combustion engine can however also constantly be operated at another optimal degree of efficiency, for example with optimal combustion with minimal environmental emissions. Under this optimum the apparatus is so arranged for transformation of kinetic and thermal energy into electrical energy that the relative maximum electrical energy is obtained.

The respective optimal degree of efficiency can be determined empirically or by means of simulation, ideally also theoretically.

The invention is basically independent of the type of the employed internal combustion engine (for example diesel, Otto, Wankel, Watt, Stirling, steam engine, turbine, etc.) or the medium to be combusted (gas, liquid, solid). The controlling factor is the constant operation at an optimal degree of efficiency.

In an advantageous embodiment, the apparatus or device supplementally includes a recovery device for the transformation of brake energy and/or potential energy into electrical energy. The term “potential energy” is understood here to mean the potential energy of a motor vehicle, in which the inventive device is located, which the motor vehicle obtains under the influence of external forces (for example, downhill propulsion by gravitation). A recovery device of this type can be, for example, an eddy-current brake.

A recovery device of this type transforms otherwise unused energy into supplemental usable electrical energy. The efficiency increases with the mass of the vehicle. Accordingly, it is particularly useful for trucks or railway vehicles.

A further alternative or additional possibility for providing supplemental electrical energy can be comprised in an exhaust gas turbo charger, which supplies supplemental electrical energy by the transformation of kinetic and/or thermal energy of the exhaust gas of the internal combustion engine.

Beyond this, supplemental electrical energy can be supplied alternatively or additionally by means of a photovoltaic device. For example, the external skin of the vehicle, in which the inventive device is located, can be covered at least partially with solar cells or even be comprised thereof.

The task with regard to the electrical driven motor vehicle to be provided can be inventively solved thereby, that the electric drive is supplied by a storage device for electrical energy, which is coupled with the above-described devices for production of electricity.

This type of vehicle according to the present invention exhibits, in comparison to the conventional motor vehicle, the advantage, that the energy stored in fuel is more completely utilized. Beyond this, heavy and bulky components for transmission of kinetic energy can be dispensed with, in particular the transmission, the cardanic shaft, and in certain cases the differential.

In comparison to conventional electric vehicles, the inventive vehicle exhibits the advantage, that it is independent of docking stations for electricity or electrical outlets, and exhibits a greater range.

In comparison to fuel cell vehicles, which are still in the developmental stage, the inventive vehicle exhibits the advantage that it requires basically already available components, which in accordance with the invention can be combined in a novel and advantageous manner and be operated differently.

Particularly suited as the drive of the inventive motor vehicle are for example electrical wheel-hub motors, due to their low weight and high efficiency.

The storage device can be a conventional battery. Alternatively or additionally capacitors or condensers can be employed, in particular for the short term storage of high current from the recuperation device.

It is particularly advantageous when the inventive motor vehicle is so equipped, when it includes a control device, which turns off the internal combustion engine upon achievement of a maximum charge of the storage device. This minimizes the risk of damage.

It is likewise advantageous when the storage device includes an interface for receiving and/or supplying electrical energy. Thereby on the one hand the mobility can be increased when, in addition to refueling with combustible fuel, electricity can also be directly recharged. On the other hand, the vehicle can also supply electricity and thus serve as a mobile electric generator.

It can also be advantageous to so design the inventive device for production of electricity as a unit that is easy to decuple from the storage device. Thereby, for example, for short distance city operations the taking-along of this unit and therewith the unnecessary weight and therewith associated energy consumption can be dispensed with. The separable or decouplable unit can be provided on a roof carrier, trunk baggage carrier or trailer and via an electrical connection is part of the inventive motor vehicle.

In the following, the inventive device for production of electricity as well as the inventive motor vehicle with electric drive and an apparatus of this type will be described in greater detail on the basis of an illustrative example:

The exemplary device for production of electricity includes, as the internal combustion engine, a diesel motor, which transforms the energy stored in fuel into kinetic energy and supplementally emits thermal energy.

The diesel motor is on the one hand mechanically coupled with a generator, which transforms kinetic energy into electrical energy. The generator is designed as a hub shaft starter generator and exhibits a high efficiency in the transformation of the kinetic energy into electrical energy.

The diesel motor is on the other hand coupled thermally with a device for transformation of the thermal energy into electrical energy. This apparatus includes two components: a device for transformation of the thermal energy of the exhaust gas, and a device for transformation of the thermal energy of the coolant. Both are in the form of thermo-elements.

The use of the thermal energy of the cooling water includes the supplemental advantage, that the otherwise necessary cooler for the motor vehicle can be dispensed with. Thereby weight is saved and the aerodynamics of the vehicle can be designed with greater freedom.

The diesel motor is constantly operated at a maximal degree of efficiency with respect to the total sum of transformed electrical energy. This maximum is experimentally determined.

The generator as well as the two devices for transformation of the thermal energy of the cooling water and of the exhaust gas are connected with a battery as storage device, which in turn is connected with four electrical wheel hub motors of the motor vehicle.

In addition, the device for production of electricity includes a recovery device for transformation of the brake energy and/or potential energy of the motor vehicle into electrical energy. The recovery device is an eddy-current brake and likewise effectively connected with the battery.

Besides this, the outer skin of the motor vehicle is covered on the roof with solar cells, which likewise are electrically conductively connected with the battery and supplementally recharge this.

The motor vehicle includes a control device, which switches off the internal combustion engine upon achievement of a maximal loading of the storage device for the electrical energy.

Besides this, the storage device exhibits a interface for receiving and supplying electrical energy. Thereby the vehicle can also be operated without the internal combustion engine as well as serve as a mobile source of electricity.

The inventive device for production of electricity has demonstrated itself in the embodiment of the above-described example as particularly suited for employment in long distance and even running heavy motor vehicles, for example trucks or also rail vehicles. In particular, substantial advantages can be achieved thereby with respect to the utilization of the energy stored in the fuel.

The invention is not limited to the above-described example, but rather can be broadly applied.

It can be utilized for example in ships. Due to the large available surfaces there, solar cells in particular are advantageous. These can even be designed as sail-like surfaces and thus provide supplemental propulsion for the ship.

1. A device for production of electricity, in particular for the propulsion of a motor vehicle, including
an internal combustion engine for providing kinetic energy with supplemental output of thermal energy,
coupled with a generator for transforming kinetic energy into electrical energy,
coupled with a device for transforming thermal energy, wherein the combustion engine is designed in such a manner, that it is constantly operated at a maximal degree of efficiency, and that the device for transformation of the thermal energy is a device for transformation of the thermal energy into electrical energy.

2. The device according to claim 1, wherein the device for transforming thermal energy into electrical energy is a device for transforming thermal energy of the internal combustion exhaust gas and/or a device for transforming the thermal energy of the cooling medium of the internal combustion engine.

3. The device according to claim 1, including a recovery device for transforming brake energy and/or potential energy into electrical energy.

4 The device according to claim 1, including an exhaust gas turbocharger, which provides electrical energy by transforming kinetic and/or thermal energy of the exhaust gas of the internal combustion engine.

5. The device according to claim 1, including a photovoltaic device.

6. A motor vehicle with an electric drive supplied by a supply device for electrical energy, wherein the supply device for electrical energy is coupled with a device including
an internal combustion engine for providing kinetic energy with supplemental output of thermal energy,
coupled with a generator for transforming kinetic energy into electrical energy,
coupled with a device for transforming thermal energy, wherein the combustion engine is designed in such a manner, that it is constantly operated at a maximal degree of efficiency, and that the device for transformation of the thermal energy is a device for transformation of the thermal energy into electrical energy.

7. The motor vehicle according to claim 6, including a control device, which turns off the combustion engine upon achievement of a maximal charge of the storage device for the electrical energy.

8. The motor vehicle according to claim 6, wherein the storage device includes an interface for receiving and/or providing electrical energy.
